(19) United States
(12) Patent Application Publication
(10) Pub. No.: US 2008/0227554 A1
(43) Pub. Date: Sep. 18, 2008

(54) Gaming machine configured for component accessibility

(76) Inventors: Joseph W. Cole, North Las Vegas, NV (US); Edward H. Comfort, North Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 12/154,407

(22) Filed: May 21, 2008

Related U.S. Application Data
(63) Continuation-in-part of application No. 11/805,318, filed on May 22, 2007.
Application No. 11/805,318 is a continuation-in-part of application No. 11/205,839, filed on Aug. 17, 2005.
(60) Provisional application No. 60/615,774, filed on Oct. 4, 2004.

(51) Int. Cl. A63F 13/08

(52) U.S. Cl. 463/46

(57) ABSTRACT

A gaming machine is configured for improved component accessibility. In one embodiment, the gaming machine has a component area having at least one display and a console located below the component area and extending outwardly towards a player of the gaming machine. At least one gaming machine component such as a currency validator and/or media dispenser is associated with the console and is accessible at a front of the console. In another embodiment, one or more components are located behind an access door located at a belly of the gaming machine.

### RELATED APPLICATION DATA

This application is a continuation-in-part of U.S. application Ser. No. 11/805,318, filed May 22, 2007, which is a continuation-in-part of U.S. patent application Ser. No. 11/205,839, filed Aug. 17, 2005, which claims priority to U.S. Provisional Application Ser. No. 60/615,774 filed Oct. 4, 2004.

### FIELD OF THE INVENTION

The present invention relates to gaming machines and, more particularly, to the configuration or arrangement of gaming machine components and accessibility thereof.

### BACKGROUND OF THE INVENTION

Gaming machines, especially those which are utilized to present wagering type games, have a wide variety of configurations. Currently, such machines are custom configured depending on the particular game or games which the machine is intended to present. For example, the machine may be configured to present a video-type wagering game, such as video poker. In that case, the machine will include a video display. The machine may be configured to present a game of slots and an associated bonus game. In that instance, the gaming machine may include a set of rotatable wheels along with a video display for displaying bonus game information.

In order to accommodate the various differing components for presenting these different games, the gaming machines for presenting those games are custom configured for mounting and containing the components.

In addition, it is generally desirable for gaming machines presenting different games to have different appearances. The difference in appearance is useful in aiding player in identifying particular machines. For example, by providing a gaming machine with a particular appearance, one company may distinguish their machines from another company's machines, enabling players to locate those machines.

Unfortunately, there is substantial cost associated with the development of a gaming machine. Significant resources must be expended to engineer the specific gaming machine configuration. Further, custom tooling and parts may need to be created to manufacture the machine. These and other factors increase the cost of producing gaming machines.

Another problem with gaming machines is that in many cases, configuration of the machine into a pleasing appearance makes various of the components thereof relatively inaccessible. Thus, routine service and maintenance of the gaming machine may be very time consuming and expensive.

### SUMMARY OF THE INVENTION

One aspect of the present invention is a component configuration for a gaming machine, such as a gaming machine with improved component accessibility.

In one embodiment, a gaming machine has a component area and a console. The component area may have at least one display. The console is preferably located below the component area and extends outwardly towards a player of the gaming machine.

At least one gaming machine component is associated with the console. In a preferred embodiment, the components associated with the console comprise a media dispenser and a currency validator. In one embodiment, the console extends from a main door of the gaming machine. The components may be mounted to the main door so as to be movable therewith.

In a preferred embodiment, the media dispenser is configured to move outwardly of the console, thereby providing greater access thereto. The media dispenser may be mounted on a releaseable slide, permitting the media dispenser to move horizontally outward of the console.

In one embodiment, the console has a front defined at least in part by a moveable panel. In one embodiment, the panel is hinged to the console. The panel defines one or more apertures for accessing the components in normal use. For example, the panel may define an aperture through which currency may be fed to the currency validator, and/or an aperture through which tickets or other media may be dispensed to the player from the media dispenser. The components are located behind the panel in its closed position, but accessible when the panel is in its open position.

In accordance with another embodiment of the invention, one or more gaming machine components are located behind an access door. Preferably, the access door is located at a belly portion of the gaming machine, below a console thereof. The access door may be connected to a main door of the gaming machine.

Further objects, features, and advantages of the present invention over the prior art will become apparent from the detailed description of the drawings which follows, when considered with the attached figures.

### DESCRIPTION OF THE DRAWINGS

FIG. 1 is a perspective view of an embodiment gaming machine of the present invention arranged into a first configuration;

FIG. 2 is a perspective view of a gaming machine door assembly in accordance with another embodiment of the invention;

FIG. 3 is an exploded view of the door assembly illustrated in FIG. 2;

FIG. 4 is a perspective view of a gaming machine door assembly configured in accordance with another embodiment of the invention;

FIG. 5 is an exploded view of the door assembly in accordance with another embodiment of the invention;

FIG. 6 illustrates a display mounting configuration in accordance with the present invention;

FIGS. 7 and 8 illustrate a component mounting configuration for a gaming machine in accordance with an embodiment of the present invention;

FIG. 9 illustrates a panel opening/closing biasing mechanism in accordance with an embodiment of the present invention;

FIG. 10 illustrates a gaming machine providing component accessibility in accordance with another embodiment of the invention;

FIG. 11A illustrates a gaming machine providing component accessibility in accordance with yet another embodiment of the invention; and

FIG. 11B illustrates an alternate embodiment of the configuration illustrated in FIG. 11A.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

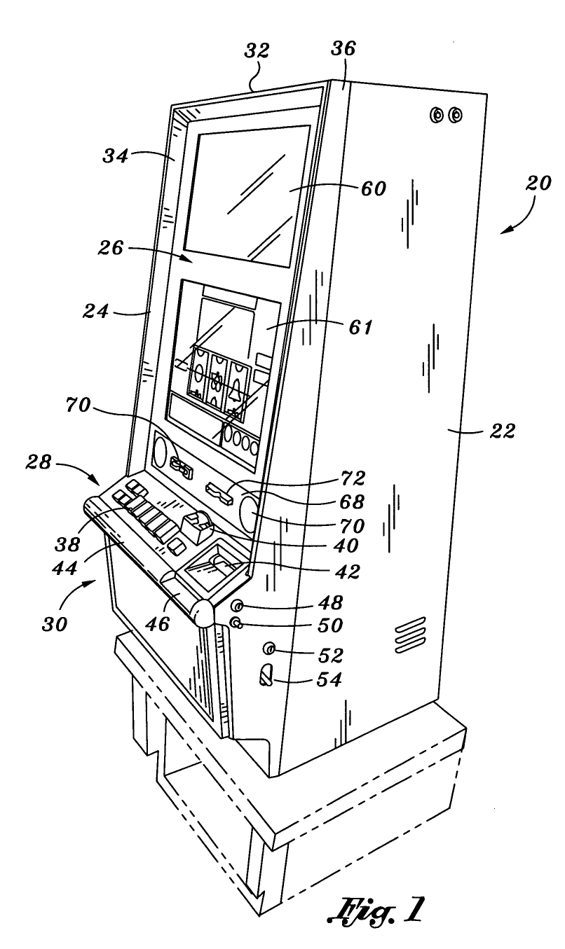

Various embodiments of the invention comprise gaming machines permitting multiple configurations and gaming machines with improved component accessibility and appearance. FIG. 1 illustrates one embodiment of such a gaming machine 20 in accordance with the present invention. The gaming machine 20 includes a housing or cabinet 22. The housing or cabinet 22 is configured to support and/or contain one or more gaming machine components.

The housing 22 may have a variety of configurations and be a variety of shapes and sizes. As illustrated, the housing 22 is configured so that the gaming machine 20 has an “upright” configuration. In this configuration, the housing 22 has a top, a bottom, a pair of opposing sides and a back (not visible).

A door 24 is located at a front of the housing 22. The door 24 is movable between a first, open position whereby access is permitted to an interior of the gaming machine 20, and a second, closed position (as illustrated in FIG. 1) in which access to the interior is generally prevented. In the embodiment illustrated, the entire front of the housing 22 is, when the door 24 is in it second position, closed by the door 24. In other embodiments, the door 24 could be smaller than the entire front of the housing 22, such that the door 24 allows access to only a portion of the interior of the housing 22, the remaining front portion of the housing closed by panels, housing wall members or the like.

Various embodiments of the invention comprise a gaming machine door which may be arranged to have a variety of configurations and desirable appearances. One embodiment of a door which may be arranged into a variety of configurations will be described with reference to FIGS. 1-3. Referring to FIG. 1, the door 24 defines a component area 26, a button panel, mount or console area 28, and a lower panel 30. In a preferred embodiment, the component area 26 is positioned above the button panel 28, and the lower panel 30 is positioned below the button panel 28.

As illustrated, the component area 26 is a space between the button panel 28 and a periphery of the door 24, that periphery having a top portion 32 and side portions 34,36. In one embodiment, the component area 26 is generally rectangular in shape, being about twelve to twenty (12-20) inches in width and about twenty-four to thirty-six (24-36) inches in height.

As described in more detail, the component area 26 is configured to accept a plurality of gaming machine components. Preferably, one or more of the components are mounted to the door 24, and face outwardly towards a player of the game. The components may include, but are not limited to, displays such as LCD, LED, CRT, plasma, DLP and others, keypads, media dispensers (such as ticket printers, bar code printers, smart card printers and other devices configured to output a media (card, ticket or other object) having information associated therewith) and readers (such as bill validators, ticket readers, smart card and magnetic stripe card readers), speakers and other devices.

Preferably, the button panel 28 comprises an outwardly extending support portion of the door 24. As illustrated, the button panel 28 includes an outwardly extending, somewhat downwardly sloping support surface. Preferably, one or more components of the gaming machine 20 are supported or associated with the button panel 28. In one embodiment, these components include one or more buttons 38 or other devices for accepting player input, a coin acceptor 40 and a media reader 42 (such as a bill validator). Other or additional components may be provided. In particular, as detailed below, the components which are associated with the button panel 28 may vary depending upon the components which are located elsewhere on the machine and the desired configuration of the machine, among other factors.

In one embodiment, a bumper or cushion 44 is provided at front edge of the button panel 28. Preferably, the bumper 44 comprises a cushioned or somewhat compressible member. In one embodiment the bumper 44 may be constructed of a foam material covered by a protective coating or cover.

In a preferred embodiment, the bumper 44 extends from one side of the button panel 28 to the other, thus providing a cushion at the front or outer-most extending portion of the button panel 28. As illustrated, a cut-out or trough area 46 may be provided in the bumper 44 in order to facilitate access to the media reader 42. As illustrated, this cut-out or depression 46 is located in a top portion of the bumper 44 in alignment with a guideway portion of the media reader 42.

The lower panel 30 preferably covers one or more gaming machine 20 components located there behind, such as within the housing 22 of the gaming machine 20. Greater details of the panel 30 are provided below.

In one embodiment, the lower panel 30 may include a latching and/or locking mechanism which controls movement of the panel 30 between an open and closed position. In one embodiment, a locking mechanism includes a key-actuated lock 48. A latching mechanism includes a movable lever 50. In a preferred configuration, the movement of the lever 50 may be utilized to unlatch the panel 30, permitting its movement from a closed to an open position. Preferably, movement of the lever 50 is controlled by the lock 48. When the lock 48 is locked, then the lever 50 can not be actuated and the panel 30 can not be opened. As illustrated the lock 48 and lever 50 are preferably mounted to the door 24.

Movement of the door 24 from the closed to the open position may be similarly controlled. As illustrated, a door lock 52 and lever 54 are preferably mounted to the housing 22.

Advantageously, the gaming machine 20 of the invention may be assembled so that the gaming machine 20 has a variety of different configurations. Preferably, the gaming machine 20 may also be converted between a first and at least one second (or other) configuration. In this manner, the gaming machine 20 may be custom configured to include specific desired components and to have a specific desired appearance, from among many different possible combinations of components and many possible different possible appearances.

In a preferred embodiment, the ability to configure or convert the gaming machine 20 is facilitated by the ability to arrange components relative to the door 24, such as within the component area 26. In addition, however, other components may be associated with the button panel 28. As described herein, the configuration of the door of a gaming machine may be changed, including the appearance thereof (such as the shape, superficial effects or the like), the components associated therewith (such as displays, dividers, or the like), or the components with which the door 24 is associated or cooperates (such as displays mounted to the gaming machine housing which the door closes over).

FIG. 1 illustrates one example configuration of the gaming machine 20. As illustrated, in this embodiment, two displays 60,61 are located in the component area 26, as well as a component bar or panel 68. In the embodiment illustrated, the component bar or panel 68 supports components of a player tracking device, including speakers 70, a media reader 42 (such as a magnetic stripe card reader) and a media dispenser 72 (such as ticket printer).

In a preferred embodiment, components such as the displays, component panels and the like are mounted to the door 24. In one embodiment, the component area 26 comprises a display window or opening, that window or opening framed by the door. The displays and other components are preferably connected to the door so as to be viewable through the opening in the door. The components could also be located at the front of the door for access/viewing. In such a configuration, the components need not be aligned with an opening in the door.

One embodiment of a mounting configuration for a display, such as an LCD panel, is detailed in U.S. Pat. No. 6,860,814 which is incorporated by reference in its entirety herein. As disclosed therein, such panels may be mounted to a rear of the door 24 so as to be visible through the opening comprising the component area 26.

In one embodiment, glass or a similar suitable covering may be located over the displays for protecting the surfaces of the displays. A bezel may be located around the display or displays or other components, for setting those components off from one another visually. There may be more than one bezel, or there may be a single bezel, with the divider extending over the bezel.

It will be appreciated that the configuration of elements associated with the button panel 28 may vary, including as dependent upon what components are located in the component area 26. For example, if a media reader, such as magnetic-stripe card reader or smart card reader, is located in the component area, then that component may not need to be located at the button panel 28 or elsewhere on the machine.

As indicated, the gaming machine may be configured to support other components. For example, the gaming machine might be configured as a reel-type machine and include one or more reels which are mounted for display in the component area (such as mounted to the door or there behind for viewing through the opening).

Advantageously, this aspect of the invention provides a “generic” gaming machine structure which allows for multiple component configurations, thus allowing the gaming machine to be “customized.” The embodiment gaming machine thus substantially reduces the cost associated with production of gaming machines having a variety of different configurations. At the same time, the gaming machine supports a nearly limitless number of configurations. This allows production of various gaming machines which have unique appearances.

The number of appearances of the gaming machine may be further enhanced with superficial effects. For example, the door perimeter, dividers and the like may be chrome or gold plated or otherwise colored in a various shades, and the lower panel may include various graphics, among other things. This further enhances the ability to make the gaming machine distinct in appearance. For example, various configurations of the gaming machine may be developed for “themed” games, and the graphics and the like may be provided to match and promote that theme.

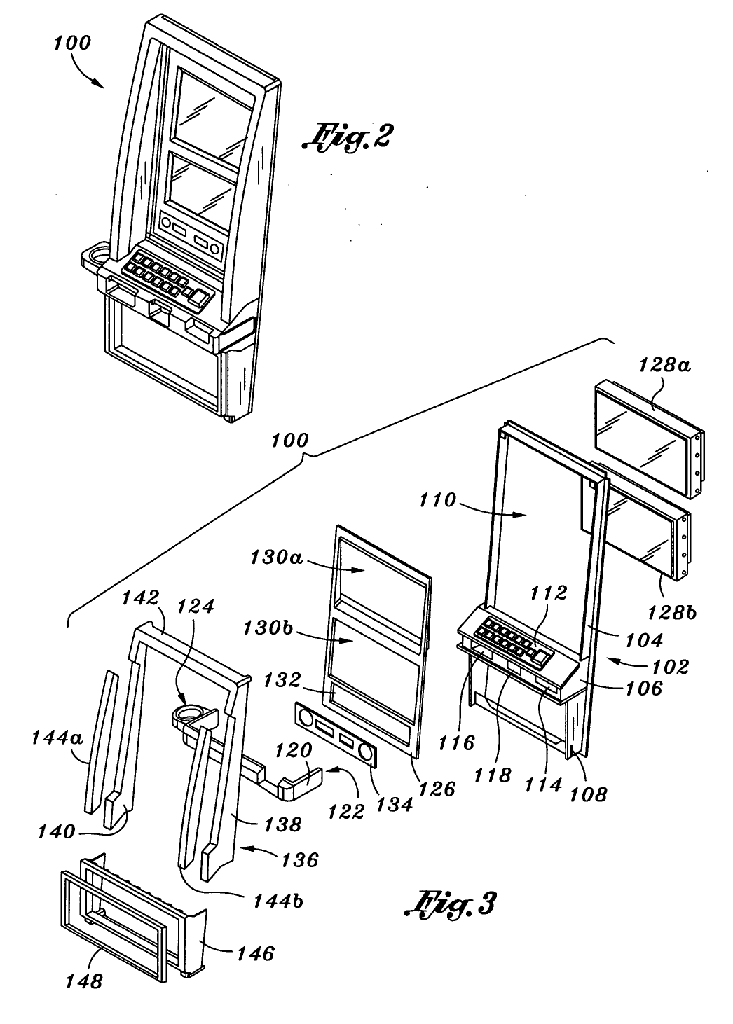

Another embodiment of the invention will be described with reference to FIGS. 2-3. These figures show additional embodiments of the invention wherein the configuration of a gaming machine and its appearance, may be changed.

FIG. 3 illustrates a gaming machine door or door assembly 100 constructed from a number of components, the configurations of which allow the configuration or appearance of the door 100 to be varied. As illustrated, the door 100 includes a door frame 102. In one embodiment, the door frame 102 comprises a support structure for one or more other components. The door frame 102 may be constructed from plastic or other material. In one embodiment, the door frame 102 is preferably configured to conduct electricity and be sufficiently strong and rigid to support components, and therefor may be constructed of metal.

In one embodiment, the door frame 102 preferably comprise or defines a periphery of the door, namely a pair of sides and a top and bottom thereof. The frame 102 extends around or defines a main or central opening. The door frame 102 generally has a front and a rear, corresponding to the position of the door when connecting to a housing of a gaming machine.

In one embodiment, the door 100 includes a support panel 106. The support panel 106 preferably extends between the opposing sides of the door frame 102 and divides the door frame 102, including the main opening, into a top or upper portion 104 and a bottom or lower portion 108. It will be appreciated that the position that the support panel 106 is connected to the door frame 102 generally determines the relative sizes of the upper and lower portions 104, 108. Thus, by changing or adjusting the position of the support panel 106, the appearance of the door 100, and thus a gaming machine with which the door is associated, may be varied.

The shapes and sizes of these various portions of the door frame 102 may vary, including based upon the desired configuration of the gaming machine. In one embodiment, the top portion 104 and bottom portion 108 are configured to accept one or more components or other elements therein. In this regard, the top portion 104 defines a component area 110.

The support panel 106 comprises a support for various components of the gaming machine. In one embodiment, the support panel 106 extends the width of the door and outwardly thereof, such as for supporting one or more buttons. In one embodiment, a button panel 112 which includes or supports one or more buttons or player input devices is mounted to the support panel 106. In other embodiments, the buttons or other input devices could be mounted directly to the support panel 106.

The button panel 112 may have a variety of configurations. In a preferred embodiment, the button panel 112 is configured to be electrically conductive and is connected to the door frame 102 in a manner providing an electrically conductive path there between.

In one embodiment, one or more components may be associated with a gaming machine so as to be located behind the support panel 106 when the door 100 is in a closed position. Alternatively, or in addition, one or more components might be mounted directly to the door 100. For example, a bill or currency validator might be mounted to the door 100. In one embodiment, the support panel 106 may define an opening 114 there through in alignment with an opening of the bill validator. The support panel 106 might similarly define an opening 116 corresponding to a card reader and an opening 118 corresponding to a ticket printer. Of course, the specific configuration of the support panel 106 might vary depending upon the variety of components which the gaming machine includes.

In one embodiment, the door assembly 100 may include a bumper 120. The bumper 120 may be configured to be located at the periphery of the support panel 106. In one embodiment, the support panel 106 may define a recessed area for accepting a portion of the bumper 120. The bumper 120 may comprise a cushioned or otherwise energy absorbing or soft member. In one embodiment, the bumper 120 may be molded.

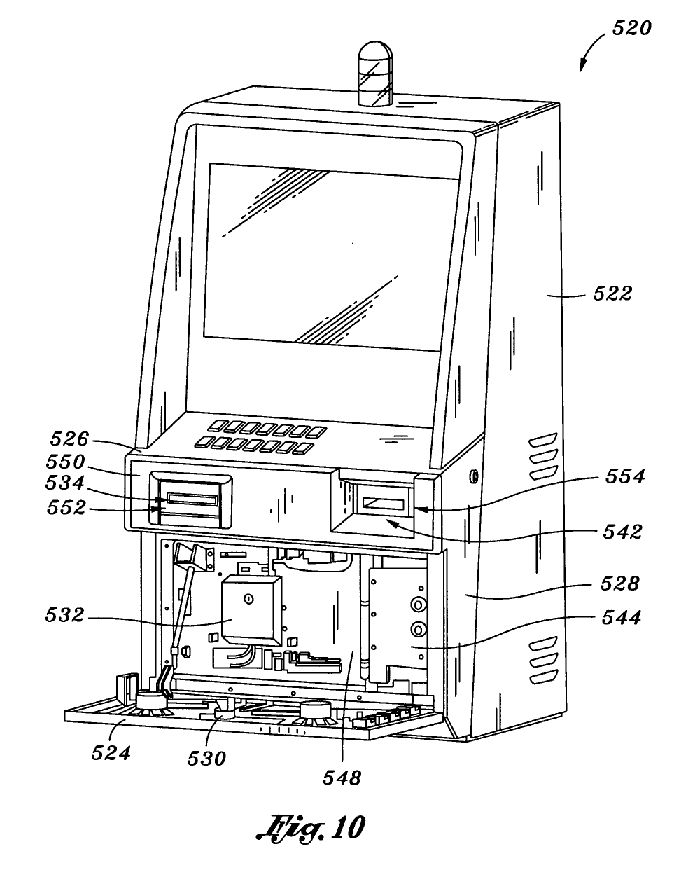

As illustrated, the bumper 120 has a middle portion and opposing first end 122 and second ends 124. The first and second ends 122,124 extend generally perpendicular to the middle portion. As illustrated in FIG. 8, when mounted to the support panel 106, the bumper 120 is preferably located at a front or forward position of the support panel 106. In one embodiment, the first and second ends 122,124 thereof extend around the sides of the support panel 106.

The configuration of the bumper 120 may vary. In one embodiment, as illustrated, a cup holder is located at the second end 124 thereof. Of course, the bumper 120 need not include a cup holder or it might include more than one cup holder. As also illustrated, the bumper 120 may define one or more cut-outs or similar areas for alignment with one or more of the openings in the support panel 106.

In a preferred embodiment, the bumper 120 is selectively connectable to the support panel 106. In this manner, bumpers of different color, shape or the like may be associated with the frame 102 in a manner allowing the configuration of the door assembly 100 to be varied.

In one embodiment, one or more display devices may be associated with the door. In one embodiment, the one or more display devices may be directly mounted to the door frame 102. In other embodiments, the door could be configured to simply be associated with such devices, such as by having those devices mount to a gaming cabinet with which the door is associated and the door being located adjacent thereto when the door is in a closed position.

The display devices may vary, such as depending upon the configuration of the gaming machine. For example, the display devices may comprise video displays such as plasma, LCD, LED, CRT or the like, or one or more spinning or rotating reels, wheels or other devices.

In one embodiment, the door assembly 100 includes a bezel 126. The bezel 126 is preferably selectively connectable to the door frame 102. The bezel 126 may be associated with the top portion 104 of the frame 102, so as to be located in the component area 110.

The particular shape and size of the bezel 126 may vary, including depending upon the desired appearance of the door assembly 100 and the particular components with which the bezel is to be associated. In one embodiment, the bezel 126 defines at least one opening through which a display device may be viewed at one or more times. In the example illustrated in FIGS. 2 and 3, the bezel 126 is configured to be associated with two video displays 128a, 128b. As such, the bezel 126 comprise a frame which defines two display openings 130a,130b. In one embodiment, the openings 130a,130b are located one above the other. In this configuration, the first and second displays 128a,128b are configured to be viewed through the openings 130a,130b of the bezel 126.

In a preferred embodiment, the displays 128a,128b may be mounted to the door frame 102 so as to be part of the door assembly 100. In this configuration, the displays 128a,128b may move with the door when it is opened and closed relative to a gaming machine.

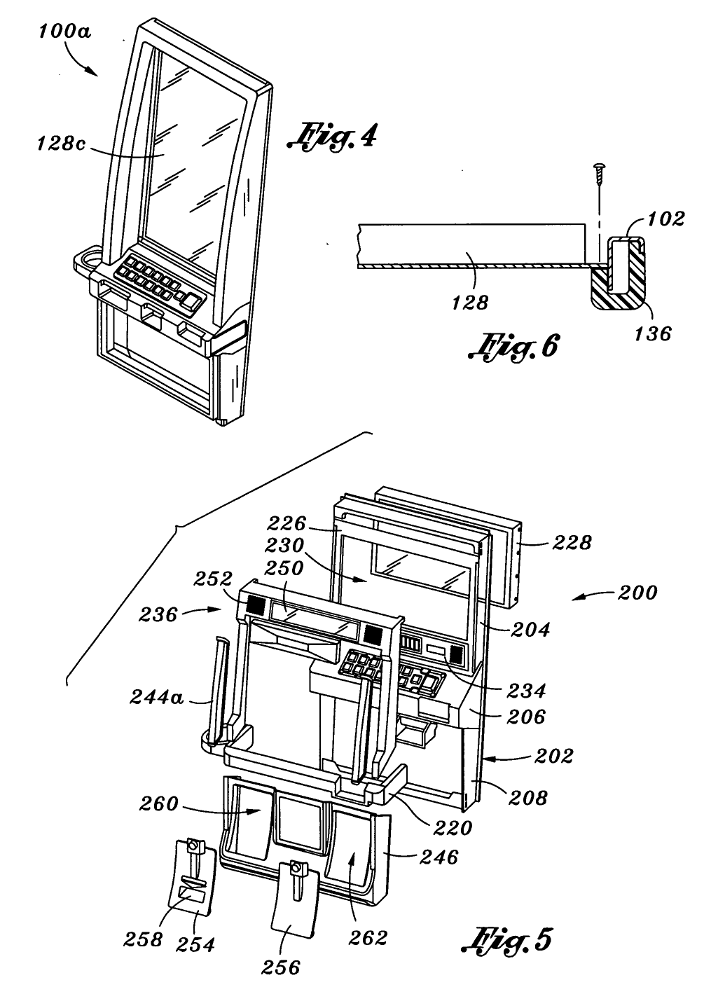

It will be appreciated that the configuration of the bezel 126 may vary depending upon the desired configuration of the door assembly 100. For example, the bezel 126 may define only a single display opening or it might define more than two openings. FIG. 4, for example, illustrates a door assembly 100a in which the bezel defines a single opening for viewing of a single display 128c there through. As illustrated, this particular door assembly 100a has a different appearance and different configuration (utilizing a single display in a “portrait” configuration rather than one or more displays in “landscape” configuration).

Referring again to FIG. 3, the bezel 126 may define other openings. For example, the bezel 126 may define a component opening or area 132. One or more components may be configured to align with or be located in this opening. For example, a component panel 134 may be located in this area. The component panel 134 may be configured to cooperate with or have associated therewith, one or more components. Such components might comprise one or more speakers, one or more displays, a card or other media reader and/or other devices.

In the configuration illustrated, the component panel 134 is located below the display openings 130a,130b. However, the bezel 126 could have a variety of other configurations, such as where the component panel 134 is located between or above those openings.

In a preferred embodiment, the bezel 126 is constructed of metal or other electrically conducting material. Further, the bezel 126 is preferably connected to the door frame 102 so that an electrically conductive path is provided there between. The bezel 126 could be constructed of other materials, however.

In one embodiment, the door assembly 100 includes an upper frame cover 136. Preferably, the upper frame cover 106 is located over a front portion of the door frame 102, thus covering or enclosing that portion of the door frame 102.

In order to permit the appearance of the door assembly 100 to be varied/customized, the configuration and/or appearance of the upper frame cover 136 may vary. In one embodiment, the upper frame cover 136 is configured to extend around the top portion 104 of the door frame 102. The upper frame cover 136 thus includes a first leg 138, a second leg 140 and a top portion 142, corresponding to the same portions of the top portion 104 of the door frame 102.

The upper frame cover 136 may be configured to be removably attached to the door frame 102, such as by being press-fit into engagement therewith, or by being configured to attach thereto with one or more fasteners (such as tabs which extend therefrom into mating holes or slots in the door frame, or with screws or the like).

The upper frame cover 136 may be constructed from a variety of materials. For example, the upper frame cover 136 may be constructed of plastic, such as in a molding process. Preferably, the upper frame cover 136 is configured to define an electrically conductive pathway from an exterior thereof to the door frame 102. In one embodiment, at least a portion of the upper frame cover 136 may be plated with metal or another conductive material. In other embodiments, conductive pathways may be defined through the upper frame cover 136 (such as by embedding conductive particles or material therein).

The upper frame cover 136 may have a variety of shapes and exterior treatments, such as colors. In one embodiment, the upper frame cover 136 may be constructed from more than one element, or have other elements associated therewith. As illustrated, inserts 144a,144b may be connected to each leg 138,140 of the upper frame cover 136. In this manner, the upper frame cover 136 may be configured to have one appearance without the inserts 144a,144b and may have a variety of other configurations depending upon the inserts 144a,144b associated therewith. The shape and size of the inserts 144a,144b may vary.

In one embodiment, one or more components or elements may be associated with the bottom or lower portion 108 of the door frame 102. In one embodiment, the lower portion 108 of the door frame 102 may be utilized as a display area. One or more electronic or other displays, such as back-illuminated glass or other signage, may be located in this area. Such displays or signage may be supported by the door frame 102. In other embodiments, the door assembly 100 could be configured to cooperate with such elements (such as by being closed over those elements).

In one embodiment, the door assembly 100 includes a lower frame cover 146. Preferably, the lower frame cover 146 is mounted over a portion of the front of the door frame 102 to cover the door frame. The lower frame cover 146 may be similar to the upper frame cover 136, except configured to be located at the lower portion 108 of the door frame 102. As with the upper frame cover 138, the configuration of the lower frame cover 146 may be varied in order to change the appearance thereof. For example, the shape and/or color or texture thereof may be varied.

As illustrated, a bezel or trim element 148 may be connected to the lower frame cover 146. This element 148 might be chrome or have other appearances.

FIG. 3 shows the door assembly 100 as configured in accordance with one embodiment of the invention. As illustrated, this configuration includes two video displays. FIG. 4 illustrates another configuration door assembly 100a including only a single video display. As indicated above, however, the principles of the invention may be applied so as to generate door assemblies having a wide variety of appearances.

As indicated above, in one embodiment, one or more displays may be mounted to the door frame 102. FIG. 6 illustrates one embodiment of a display mounting arrangement. As illustrated, the video display 128 mounts to the upper frame cover 136. For example, the upper frame cover 136 may be mounted to the door frame 102 and have a portion or face which extends into the component area defined by the door frame 102. The display 128 may mount to this face or portion of the upper frame cover 136.

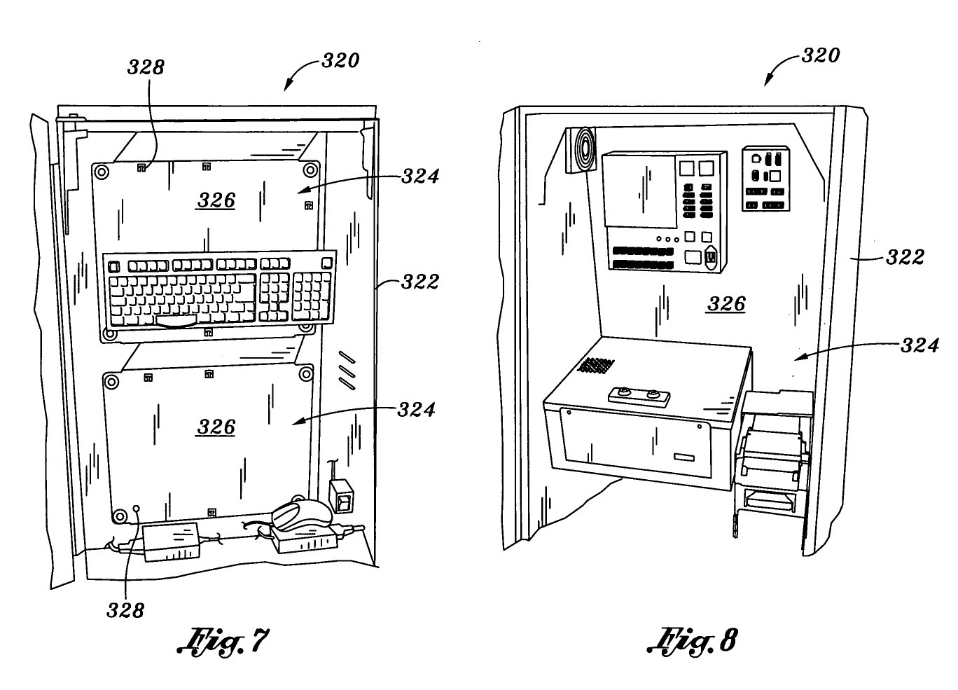

FIG. 5 shows yet another configuration of a door assembly 200. In this embodiment, like reference numbers have been given to like elements to those of the embodiment illustrated in FIG. 9, for ease of reference.

Once again, the door assembly 200 includes a door frame 202. The door frame 202 is similar to that above, including an upper portion 204, a component panel 206 and a lower portion 206. Further, the door assembly 200 includes a bezel 226 which defines a display opening 230 for alignment with a display 228. As illustrated, the bezel 226 includes a component portion or panel 234.

The door assembly 200 also includes a bumper 220 mounted to the panel 206, as well as an upper frame cover 236 and a lower frame cover 246. Once again, inserts 244a,244b may be provided for mating with the upper frame cover 236.

In this configuration, one or more components are associated with the upper frame cover 236. As illustrated, one or more displays 250, speakers 252 or the like may be mounted to or supported by the upper frame assembly. As illustrated, these components are located in the top portion of the upper frame cover 236. They might be located in other areas.

FIG. 5 also illustrates another configuration of a lower frame cover 246. In this configuration, the lower frame cover 246 does not define a single main opening or display area. Instead, the lower frame cover 246 includes a first movable panel 254 and a second movable panel 256. These panels 254,256 may be movably connected to the lower frame cover 246 or otherwise be mounted to move relative to the door frame 202. These panels 254,256 may selectively control access through corresponding openings 260,262 in the lower frame cover 246.

In one embodiment, a locking mechanism may be provided for selectively locking each panel 254,256 into its closed position. The panels 254,256 may have a variety of sizes and shapes. As illustrated, at least one of the panels 254 might, for example, define a slot 258 through which tickets or other media or elements may be dispensed.

In accordance with a method of the invention, a gaming machine door may be assembled into a variety of configurations. In one embodiment, a support panel is connected to a door frame. The position of the support panel may be adjusted to define top and bottom portions of the door frame. A bezel is connected to the door frame along with upper and lower frame covers. The door may be connected to a housing of a gaming machine, such as via one or more hinges so as to rotate between open and closed positions.

It will be appreciated that the panels illustrated and described are exemplary, and that a wide variety of other configurations are possible. For example, the upper frame cover 236 might comprise more than one piece, such as pair of side member and a top member, thus allowing each of those members to be changed or customized. In this regard, the various panels or members may have various configurations, such as including combinations thereof into a lesser number of panels or members, or the panels comprising multiple members. It will also be appreciated that the various portions of the machine which may be changed may be other than portions of the door. For example, in one embodiment a top portion of the gaming machine may be defined by a housing thereof and a door may be located only at a lower portion of the front of the machine. In this configuration, one or more panels or facades may be associated with the main housing in order to create a particular appearance at the top front of the machine.

In accordance with the invention, a gaming machine may advantageously have various configuration for a variety of purposes, while still having the same basic design and employing the same basic components, thus substantially lowering the cost of manufacture. For example, the same gaming machine might be configured for two different casinos. In a high end market, various components of the gaming machine/door might be plated with gold or a similar precious metal to give the machine an expensive appearance. In a lower end market, various of the components of the gaming machine/door may be molded from plastic or the like to keep the cost of the machine lower. The color, texture or other attributes of those panels or members may be changed to create various different gaming machine appearances.

The same principles permit the gaming machine to be configured for different purposes. For example, the gaming machine might be configured for a traditional casino market, and thus have a traditional appearance. On the other hand, the machine might be configured to have an appearance of a lottery or arcade unit.

In a preferred embodiment, the electrically conductive paths which are defined between the components and to ground preferably have a lower resistance than other potential electrical paths. In this manner, an electric charge is most likely to follow the path defined through and/or between the components to ground, rather than other paths, such as via wiring to the gaming machine controller or the like.

In one embodiment, various components of the machine, such as a bill validator or the like, may be mounted to the door of the gaming machine using a metal bezel. Such a bezel may add to the rigidity or stiffness of the door, as well as provide an additional grounding path to the door (such as to the door frame). For example, the bill validator may be mounted to a bezel which is mounted to the back of the door frame.

In accordance with prior gaming machines, many components (such as bill validators, lights, and the like) were AC powered. These components were fairly insensitive to electric shock. However, in accordance with one embodiment of the invention, various of the components of the gaming machine may be DC powered. While these components have the advantage of using much less power, a problem has arisen that these components are much more sensitive to electric shock. In accordance with the present invention, the gaming machine is configured to prevent such shock from traveling to those components, solving this problem.

A variety of features of the invention will now be appreciated from FIGS. 2-6. These figures illustrate a door assembly which permits the configuration of a gaming machine or similar device to be customized. In particular, the appearance of the gaming machine may be changed by changing the configuration or appearance of the door including one or more of: (1) changing the location of the support panel (by moving the panel up or down, the areas above and below the support panel change sizes); (2) changing the bezel and associated components (to include one display, more than one display, a component area, such areas above or below the display(s), etc.); (3) changing the shape or appearance of the bumper; (4) changing the trim, color or other aesthetics of the door; (5) changing the one or more components located in the lower area (such as from a back-illuminated panel to a video display to a ticket printer, etc.).

In accordance with one aspect of the invention, a gaming machine door is configured to dissipate electricity/electrical shock. As is well known, players of gaming machines often transfer static electricity to a gaming machine when they touch the gaming machine. This electrical charge may flow through the circuitry of the gaming machine to various components thereof, damaging the components and/or causing malfunction thereof.

In accordance with the invention, the components of the door are configured to transmit any such electrical charges to ground, preventing them from damaging the gaming machine. As indicated above, the support panel, bezel, door frame and upper frame assembly are all preferably configured to transmit electricity. In this manner, any static or other electrical charges which are transferred by the player are transmitted through these components to ground, rather than through the circuitry of the machine. In particular, these components of the door are all connected to form an electrical pathway. Thus, for example, if the player touches one of the buttons on the button panel and an electrical charge is transmitted, it passes to the button panel and then the door frame and to ground.

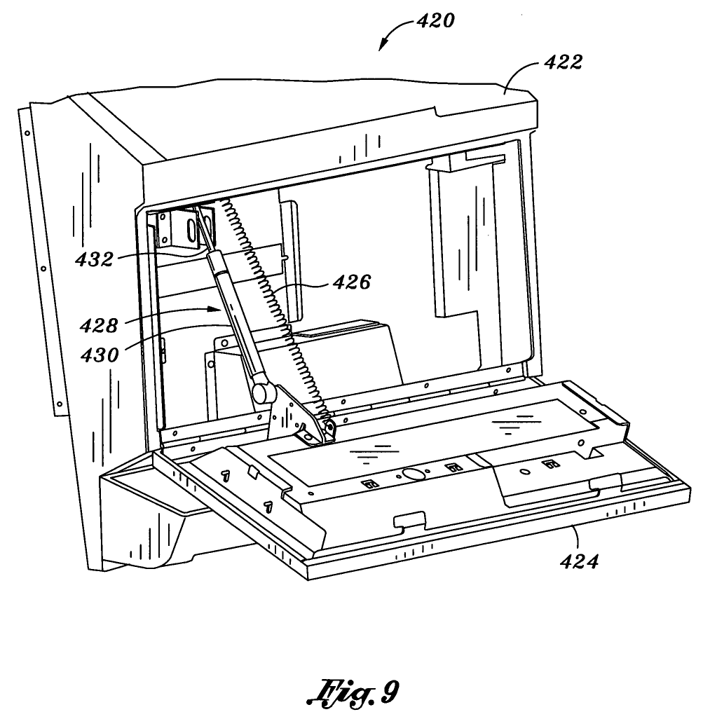

Various other aspects of the invention will now be described. Referring to FIGS. 7 and 8, one embodiment of the invention is an internal component mounting arrangement for a gaming machine. FIG. 7 illustrates a gaming machine 320 having a housing or cabinet 322. The housing 322 may be configured similar to that of the gaming machine 20 illustrated in FIG. 1, and may include one or more doors or other access panels to an interior thereof.

In a preferred embodiment, one or more component mounting panels 324 are located at the interior of the housing 322. In the embodiment illustrated, two mounting panels 324 are located a rear or back of the housing 322 at the interior thereof.

The mounting panel 324 preferably defines a generally planar mounting surface 326. In one embodiment, the mounting surface 326 of the panel 324 is offset or spaced outwardly from the rear of the housing 322. For example, in one embodiment, the panel 324 comprise a metal sheet having portions of one or more edges bent rearwardly, thus defining feet extending from the mounting surface 326, those feet when engaging the rear of the housing 322 offsetting the mounting surface 326 from the housing 322. Of course, other means may be provided for spacing the mounting surface 326 from the housing 322, such as legs, spacers and the like.

The mounting panel 324 is connected to the housing 322. In one embodiment, this may be accomplished with fasteners. Welding or other means of connection may alternately be provided. Preferably, so connected to the housing 322, the mounting surface 326 of the panel 324 is generally vertically extending.

In one embodiment, a plurality of apertures 328 are provided in the mounting surface 326. The apertures 328 are configured to accept fasteners for mounting components of the gaming machine 320 thereto. The fasteners may comprise hooks, bolts or other elements. The fasteners may be separate from or integral with the gaming machine component(s).

FIG. 7 illustrates various components mounted to the two mounting panels 324. As illustrated, these components comprise a keyboard, among other things. The particular components which are mounted to the one or more mounting panels may vary. For example, FIG. 8 illustrates an embodiment where a gaming machine CPU or controller and various other components are mounted to a large panel 324.

This component mounting configuration has numerous advantages over current mounting configurations. Currently, shelves or racks are generally located in the gaming machine to provide horizontal support surfaces for components. These horizontal shelves and racks suffer from a number of drawbacks. First, the shelves dictate where components may be located. For example, depending upon the spacing between shelves, certain components may not fit between closely spaced shelves, but must be placed elsewhere. In addition, these shelves severely interfere with the flow of air through the gaming machine, making it more difficult to cool the components.

In accordance with the mounting configuration of the invention, components of the gaming machine may be mounted anywhere in the gaming machine. This allows the gaming machine to be customized for each particular application. For example, when considering the gaming machine configuration illustrated in FIG. 1, displays and other devices may be associated with the door in a plurality of configurations. In accordance with the component mounting configuration, the supporting infrastructure of the gaming machine may be altered depending upon that gaming machine configuration. For example, the position of a CPU or controller of the device may be moved to accommodate a display, card reader or the like which is mounted to the door and extends into the gaming machine.

In addition, this mounting configuration permits the interior of the gaming machine to remain substantially open. This allows air to more freely flow through the gaming machine to cool the components. The configuration also promotes access to the components for replacement and repair.

Referring to FIG. 9, one embodiment of the invention is a biasing mechanism for a gaming machine door or panel which may be moved between open and closed positions. As illustrated, a gaming machine 420 has a door or access panel 424. The door or access panel 424 is preferably moveable between a first and second position. As mounted to a housing 422 of the gaming machine 420, the door or access panel 424 may selectively provide access to the interior of the housing 422. One such panel 30 is illustrated in the gaming machine 20 illustrated in FIG. 1.

In the embodiment illustrated, the access panel 424 is hingedly mounted to the housing 422. In a preferred embodiment, means are provided for controlling movement of the panel 424 to an open position and for controlling movement of the panel to its closed position. In one embodiment, these means comprise means for biasing the panel towards an open position and means for biasing the door towards a closed position.

In a preferred embodiment, a spring 426 is connected to the door panel 424 and another member, such as a the housing 422 which supports the panel 424. As illustrated, the spring 426 may be a coil-type spring having one end connected to the panel 424 and the other connected to the housing 422. Preferably, the spring 426 is configured to bias the panel 424 towards its closed position.

A piston 428 preferably biases the panel 424 towards its open position. In the embodiment illustrated, the piston 428 has a body 430 and an arm 432. Preferably, the arm 432 is biased outwardly towards an extended position. One end of the piston 428, such as at the arm 432, is connected to the housing 422 or other support. The other end of the piston 428, such as at the body 430, is connected to the panel 430.

Preferably, the biasing forces generated by the two biasing means (in this case the spring 426 and piston 428) are carefully selected so that: (1) when a user desires to move the panel 424 from a closed to the open position illustrated in FIG. 9, the user pulls the panel 424, the piston 428 aiding in moving the panel 424 towards the open position against the biasing force generated by the spring 426, the panel 424 once in its open position being retained in that position by the piston 428 against the biasing force generated by the spring 426; and (2) when a user desires to move the panel 424 from the open back to the closed position, the user moves the panel, the spring 426 biasing the panel 424 towards the closed position against the force of the piston 428.

So configured, a biasing force aids in moving the panel 424 in each direction of movement. At the same time, a biasing force is generated which opposes movement of the panel 424, thus preventing undesirable “slamming” of the panel 424 as it is moved back and forth. For example, when the panel 424 is opened, the spring 426 serves to reduce the speed at which the panel 424 may be opened, lessening the likelihood of the panel 424 slamming open and being damaged. Likewise, the piston 428 prevents slamming of the panel 424 as it is moved to its closed position, protecting the panel 424 and components of the gaming machine located there behind.

Of course, other means may be provided which accomplish the above-stated functions. For example, more than one spring may be used. Other means for biasing may also be utilized, such as elastic cords and bands and the like.

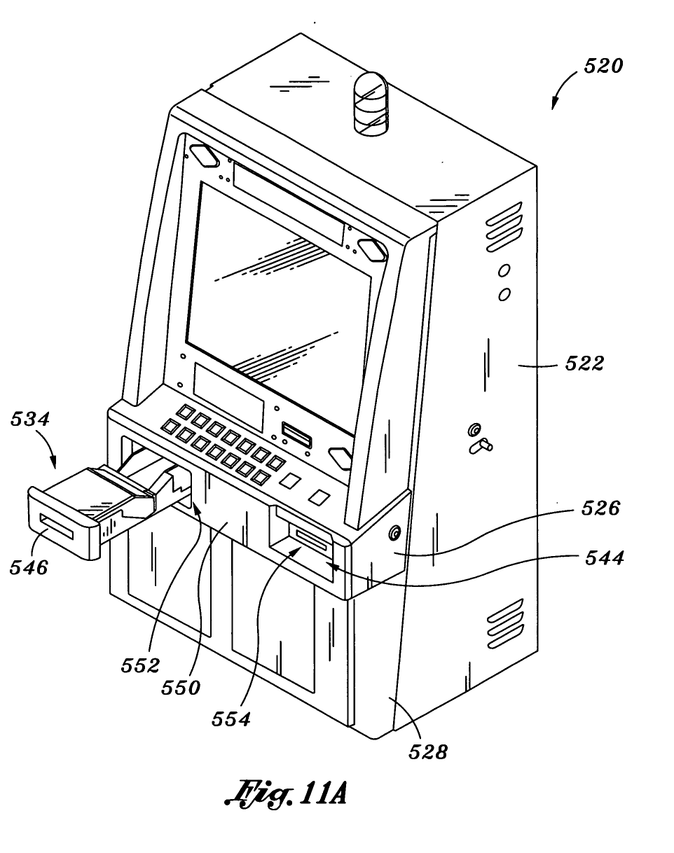

Another embodiment of the invention will be described with reference to FIG. 10. FIG. 10 illustrates a gaming machine 520 having a housing 522. The gaming machine 520 may be arranged into numerous configurations, similar to that described above, or it might have a particular configuration. Preferably, the gaming machine 520 has an access door or panel 524, similar to that illustrated in FIG. 9. Preferably, this access door 524 is located at a bottom or lower portion of the gaming machine 520, such as below a console or console portion 526 thereof.

In one embodiment, the access door 524 is associated with a main door 528. As illustrated, the main door 528 is located at a front of the housing 522 and can be moved between an open position in which access is generally provided to the interior of the housing at the front thereof, and a closed position. In this embodiment, the main door 528 provides access to a larger area or portion of the interior of the gaming machine 520 than the access door 524. In particular, the access door 524 provides sub-access to only a portion of the interior of the gaming machine 520 as compared to the main door 528, and preferably a lower portion thereof.

In other embodiments, however, the access door 524 might be associated directly with the housing 522. In that configuration, the gaming machine 520 might still have a main door or other access in addition to the access door 524, such as at another location of the housing.

Preferably, the access door 524 is movable between a first, open position and a second, closed position, relative to the gaming machine 520, and when associated with a main door 528, movable relative to the main door as well. The access door 524 may be mounted in similar fashion to that described above and illustrated in FIG. 9. In one embodiment, the access door 524 is hingedly mounted and configured to rotate about a lower edge. This permits the upper edge or portion of the access door 524 to rotate away from the gaming machine to the position illustrated in FIG. 10.

In one embodiment, a locking mechanism 530 is provided for securing the access door 524 in its second, closed position. In one embodiment, the locking mechanism 530 comprises a key-actuated rotating lever type lock. The actuator of this locking mechanism 530 may be mounted to the access door 524 and be configured to engage the main door 524 and/or the housing 522 of the gaming machine 520. Of course, other types of locking mechanisms may be utilized. Preferably, however, the locking mechanism is configured to permit the access door 524 to be opened independent of other portions of the gaming machine 520, such as the main door 522.

The access door 524 may support various components of the gaming machine 520. For example, the access door 524 may support a belly glass or other ornamentation which is visible at the front of the gaming machine 520. The access door 524 might also support one or more backlights, sound generating devices such as speakers, and/or other components.

In one embodiment, one or more components of the gaming machine 520 are located behind the access door 524 when the access door 524 is in its closed position. Thus, when the access door 524 is opened, those components are readily accessible. When the access door 524 is located at a lower or belly portion of the gaming machine 520 below the component/display area and console area, the components are located in that same area.

In a preferred embodiment, a storage compartment 532 is located behind the access door 524 in the belly portion of the gaming machine 520. The storage compartment 532 preferably comprises a generally enclosed area for housing or storing items, such as unprinted media (such as paper tickets) to be loaded into the gaming machine's media dispenser 534. In one embodiment, the storage compartment 532 may be at least partially defined by the housing 522 of the gaming machine 520 (or another element connected thereto). In another embodiment, the storage compartment 532 may comprise a container or similar element associated with the gaming machine 520.

Access to the interior of the storage compartment 532 is preferably controlled. In one embodiment, a locking mechanism is associated therewith. For example, the storage compartment 532 may have a front door which can be opened and closed, or may comprise a drawer that can be moved in and out relative to the housing 522 of the gaming machine 520. The locking mechanism may be configured to selectively control the movement of the door or drawer. In this manner, access to the storage compartment 532 may be controlled independent of access to the interior of the gaming machine 520 at the belly portion thereof.

In one embodiment, the gaming machine 520 includes a currency or bill validator 542, similar to the gaming machine 20 illustrated in FIG. 1. In one embodiment, the cash or currency box 544 to which currency is fed for storage from the validator 542 is located in the belly portion of the gaming machine 520. Preferably, the currency box 544 is located behind the access door 524. The currency box 544 may be oriented so that a handle thereof faces outwardly towards the access door 524, and so that the currency box 544 is in a generally vertical orientation so as to be inserted and removed from the gaming machine 520 in a generally horizontal direction. As illustrated, the currency box 544 is located near a side of the gaming machine 520, however, its location could change depending upon the desired location of the validator 542.

Of course, other components of the gaming machine 520 might be located in a belly portion thereof so as to be accessible when the access door 524 is opened. These component might be in addition to the storage compartment 532 and currency box 544.

In one embodiment, a panel 548 may be mounted to the back of the main door 528 or in a forward portion of the interior of the housing 522. This panel 548 may serve to inhibit access to other areas of the gaming machine 520 when the access door 524 is open. In the illustrated configuration, the currency box 544 is accessible through an opening in the panel 548. Similarly, the storage box 532 may be at least partly defined by this panel 548.

This aspect of a gaming machine 520 has numerous advantages. In most circumstances, a gaming machine operator is required to allow their personnel to open the main door of the gaming machine in order to access the components thereof. For example, personnel may open the gaming machine door in order to merely add tickets to the ticket printer. When this occurs, however, the personnel exposes the interior of the entire gaming machine, including the various controllers and the like. This compromises the security of the gaming machine when only routine service is being provided.

In accordance with the invention, components which require routine service can be serviced through a sub-access thereto. In particular, service items such as spare tickets can be accessed via the access door 524. At the same time, the main door 528 can remain locked and closed, thus preventing access to various other components of the gaming machine, such as gaming controllers and the like.

Similarly, full currency box 544 can be removed and replaced with an empty box. Access to the currency box 544 is provided via the access door 524, again without opening the main door 528.

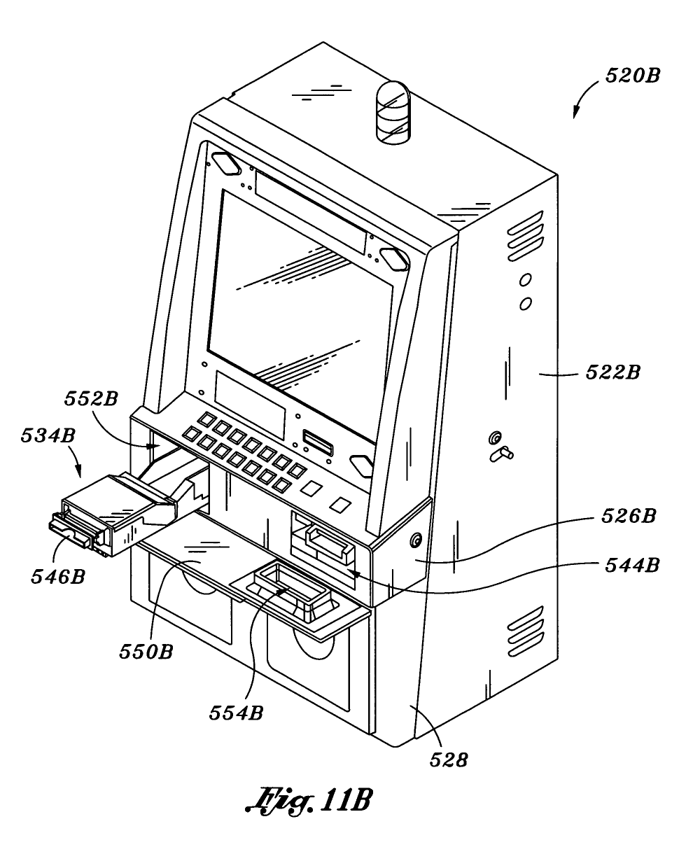

FIG. 11A illustrates additional embodiments of the invention. In one embodiment, one or more components of the gaming machine 520 which are normally mounted within the housing of the gaming machine (for security purposes) and which are normally accessible only by opening the door, are associated with the console or console portion 526 of the machine. As described above, the gaming machine 520 may have a console portion 526. This console portion 526 may be located below a component area (which preferably includes at least one display for displaying game content, such as a video display, slot reels or the like), and above a belly or bottom portion of the gaming machine 520. In one embodiment, the console portion 526 extends outwardly towards a player relative to those other portions of the machine.

In one embodiment, one or more components of the gaming machine 520 are associated with the console portion 526, and most preferably, the a front or forward-most portion of the console portion 526. This forward-most portion of the console 526 may be defined by a panel 550. This panel 550 may be generally vertically extending, thus forming a generally planar front of the console.

As indicated above, in one embodiment, the gaming machine 520 may include a media dispenser 534, such as a ticket printer. The gaming machine 520 may also include a currency validator 544. In one embodiment, at least a portion of these two components is associated with the console portion 526 of the gaming machine 520.

In a preferred embodiment, a dispenser portion 546 of the media dispenser 534 is located and accessible at the front of the console portion 526 of the gaming machine 520. The dispenser portion 546 may comprise, for example, a slot through which media, such as tickets, are expelled from the media printer 534 to the player.

Likewise, an acceptor of the currency validator 544 is located and accessible at the front of the console portion 526 of the gaming machine 520. The acceptor may comprise a slot or guide into which currency may be directed to the currency validator 544.

In one embodiment, the panel 550 defines openings through which the dispenser 546 of the media dispenser 534 and the acceptor of the currency validator 544 are accessible. For example, as illustrated in FIGS. 10 and 11A, the panel 550 may define a first opening 554 which aligns with the acceptor of the currency validator 544. Likewise, a second opening 552 in the panel 550 may be aligned with the dispenser 546 of the media dispenser 534.

To provide additional access to the media dispenser 534, the media dispenser 534 may be configured to slide or otherwise move outwardly from the console portion 526. In one embodiment, the media dispenser 534 is mounted on a slide or track, permitting it to be moved outwardly from the console portion 526. As illustrated, this outward movement may be in a generally horizontal plane. A release (not shown) may be provided for selectively releasing the media dispenser 534 to permit it to move. The release may be located in a secure location. For example, the release may be located behind the lockable access door 524, as best illustrated in FIG. 10.

The release may engage a latch or other mechanism which holds the media dispenser 534 in its retracted position. Biasing means, such as a spring, may be provided for aiding in the outward movement of the media dispenser 534.

As indicated, the media dispenser 534 and currency validator 544 are associated with the console portion 526 of the gaming machine 520. In one embodiment, these components extend rearwardly from the console portion 526, such as into the door an/or the gaming machine housing 522. For example, these components may be mounted to the main door 528 in the location of the console portion 526 so as to be accessible in the manner described above. Further, one or more portions of those components may extend rearwardly from the main door 528, such as into the interior of the gaming machine 520 behind the door (when closed). In a preferred embodiment, the media dispenser 534 is mounted to and supported by the housing 522, with the main door 528 openable and closeable relative thereto (but still facilitating easy access thereto via the front of the door 528).

FIG. 11B illustrates another embodiment of the invention. This embodiment is similar to that illustrated in FIG. 11A, and thus like reference numbers have been used with like elements to those in FIG. 11A, except that the designator “B” has been added thereto. In this embodiment, the front portion of the console portion 526B is movable relative to the gaming machine 520B. As illustrated, in a preferred embodiment the forward-most portion of the console portion 526B (and in a preferred embodiment, the forward-most portion of the gaming machine) is formed as a movable panel 550B. This panel 550B is moveable relative to the remainder of the console portion 526B. In one embodiment the panel 550B is hingedly mounted to move between a closed position in which it is generally vertically extending and forms the front of the console portion 526B (as illustrated in FIG. 10) and a second, open position in which it is moved away from the remainder of the console portion, as best illustrated in FIG. 11B. As indicated, this movement may be permitted by one or more hinges or other means of mounting. As illustrated, hinges permit the panel 550B to rotate from a generally vertical to a generally horizontal position. In particular, the panel 550B may have a top edge and a bottom edge, where the panel 550B is hinged at the bottom edge, thus permitting the top edge to move relative to the gaming machine.

In one embodiment, one or more components of the gaming machine 520B are accessible via the panel 550B. In a preferred embodiment, the media dispenser 534B is associated with the console portion 526B, at least partially behind the panel 550B. Referring to FIG. 10, the panel 550B may define an aperture 552B therein. When the panel 550B is in its first or closed position, the dispenser 546B portion of the media dispenser 534B is preferably accessible through the aperture 552B. In order to access the media dispenser 534B, the panel 550B may be moved to its second or open position. In addition, as with the embodiment illustrated in FIG. 11A, the media dispenser 546B may be moved outwardly to further facilitate access thereto.

In one embodiment, a release or other mechanism may be utilized to release the panel 550B from its closed position. A lock may be utilized to secure the panel 550B in its closed position, where movement of the panel is secured by a key-activated lock or the like.

The features of the invention illustrated in FIGS. 10, and 11A and 11B have a number of advantages. As indicated, an advantage of the gaming machine with an access panel or door is improved component accessibility and component security. In particular, using the access panel or door, various components in a limited area of space can be accessed. At the same time, the main door or other member providing greater or wider access to the interior of the gaming machine need not be utilized, thus maintaining security of other components of the gaming machine. In one embodiment, features of the gaming machine which require frequent service are arranged to be accessible via the access panel or door. This allows, for example, the currency box or container to easily be replaced when full, and blank tickets to be loaded into a media dispenser (such as printer). Other components that generally require only repair or maintenance, rather than daily or other frequent service, may be located in the more secure areas of the gaming machine.

For example, the main door of the gaming machine may be monitored and a record created of each opening and closing, for security purposes. In the configuration of the invention, access can be provided to routine service items without having to open and close the main door, thus avoiding such security triggers.

Association of components with the console portion of the gaming machine also has numerous advantages. One advantage is again that those components can be access by a sub-panel without the need to open the entire gaming machine, again improving the security of the machine. Also, the location of the components at the console of the gaming machine improves their accessibility. In particular, the components are located at the forward or front portion of the machine, rather than being deep in the interior of the machine, such as behind other components where they are difficult to access.

Of course, the embodiments of the invention may have various configurations. For example, the components associated with the console may be accessible in various manners. For example, the console panel may be openable in other ways (by sliding, rotating to the side, etc.) and may comprise other than just a cover (the entire console might open and close relative to the main door, for example).

It will be appreciated that the various features of the invention may be utilized apart from the others, and may have a variety of applications. For example, the grounding configuration of the door may be applied to gaming machines having doors of other configurations. Similarly, the gaming machine support stand, access door and console-associated component configurations might be utilized with a wide variety of gaming devices, whether such can be arranged into multiple configurations or not.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a housing having a front;
a display area at said front of said housing, said display area having at least one display configured to display game information;
a console located below said display area and extending outwardly of said display area towards a player of said gaming machine, said console having a front; and
a media printer extending rearwardly from said front of said console into said gaming machine, said media printer having a dispenser accessible at said front of said console.

2. The gaming machine in accordance with claim 1 wherein said panel defines an opening therein and said dispenser of said media printer is accessible through said opening.

3. The gaming machine in accordance with claim 1 wherein said console comprises a portion of a door located at said front of said gaming machine.

4. The gaming machine in accordance with claim 1 wherein said media dispenser comprises a ticket printer.

5. The gaming machine in accordance with claim 1 wherein at least a portion of said media dispenser is movable outwardly of said console.

6. The gaming machine in accordance with claim 1 wherein said panel is hingedly mounted to said console.

7. The gaming machine in accordance with claim 6 wherein said panel has a top edge and a bottom edge and said top edge is configured to move away from said console.

8. The gaming machine in accordance with claim 6 including at least one latch for selectively retaining said panel in said second position.

9. The gaming machine in accordance with claim 1 further comprising a currency validator associated with said console, said currency validator having an acceptor accessible through said panel.

10. The gaming machine in accordance with claim 1 wherein said front of said console is defined by a panel which is generally vertically extending and forms a forward-most portion of said gaming machine.

11. A gaming machine comprising:
a housing having a door located at a front thereof, said door movable between first and second positions;
at least one display located at a top portion of said door;
a console extending outwardly from said door below said at least one display, said console having a front defined by a panel having at least one opening therein; and
at least one of a media dispenser or currency validator mounted to said door at said console and accessible through said at least one opening in said panel.

12. The gaming machine in accordance with claim 11 wherein a media dispenser is movably mounted to said door between a first retracted position and a second extended position in which at least a portion of said media dispenser extends outwardly of said console through said panel.

13. The gaming machine in accordance with claim 11 wherein said panel comprises a front of said console facing away from said machine towards a player thereof.

14. The gaming machine in accordance with claim 11 wherein said panel is hingedly connected to said gaming machine and movable between an open and a closed position.

15. The gaming machine in accordance with claim 12 wherein a media dispenser release latch is located in a belly portion of said gaming machine below said console.
